(19) United States
(12) Patent Application Publication
(10) Pub. No.: US 2018/0278635 A1
(43) Pub. Date: Sep. 27, 2018

(54) APPARATUS, METHOD, AND COMPUTER PROGRAM FOR DETECTING MALWARE IN SOFTWARE DEFINED NETWORK

(71) Applicant: Korea Advanced Institute of Science and Technology, Daejeon (KR)

(72) Inventors: Seungwon Shin, Daejeon (KR); Chanhee Lee, Daejeon (KR); Changhoon Yoon, Daejeon (KR); Sang Kil Cha, Daejeon (KR)

(73) Assignee: Korea Advanced Institute of Science and Technology, Daejeon (KR)

(21) Appl. No.: 15/811,248

(22) Filed: Nov. 13, 2017

(30) Foreign Application Priority Data
Mar. 23, 2017 (KR) 10-2017-0036876

(51) Int. Cl. H04L 29/06; G06F 9/54; G06N 99/00

(52) U.S. Cl. CPC H04L 63/1425; G06N 99/005; G06F 9/547; H04L 63/145

(57) ABSTRACT

Disclosed are an apparatus, a method, and a computer program by which it is determined whether a target network program generated in a software defined network is malicious by extracting a feature of a behavior graph of the target network program and applying machine learning to the behavior graph. Accordingly, a security and safety of a software defined network may be improved by detecting whether a computer program is malicious before the malware is installed.

### CROSS-REFERENCE TO RELATED APPLICATIONS

A claim for priority under 35 U.S.C. § 119 is made to Korean Patent Application No. 10-2017-0036876 filed on Mar. 23, 2017, in the Korean Intellectual Property Office, the entire contents of which are hereby incorporated by reference.

### BACKGROUND

Embodiments of the inventive concept relate to an apparatus, a method, and a computer program for detecting malware, and more particularly, to a technology of determining whether a target network program is malicious through clustering of the target network program by deriving a behavior graph of the target network program generated in a software defined network and applying machine learning to the derived behavior graph.

Software defined networking (hereinafter, SDN) refers to a technology of managing all network equipment of a network through an intelligent central management system. In the SDN technology, a control operation related to processing of packets is performed by a software type controller instead of conventional hardware type network equipment so that more various functions may be developed than in the traditional network structure.

Unlike the traditional network environment, a logically centralized control plane exists in the SDN system, and various network programs are driven on the control plane. In the system structure, the entire system is badly influenced by malware.

Hereinafter, an example of badly influencing an SDN system will be described in detail with reference to FIG. 1.

FIG. 1 illustrates an example of malware badly influencing a traditional SDN environment.

Referring to FIG. 1, in an SDN environment, malware may communicate (1) with an SDN controller to recognize (2) data flows from host A to host B.

The malware may interrupt (4) data from host A to host B by arbitrarily controlling (3) a function of an open flow switch that processes packets in a data plane through a SDN controller.

Here, the open flow switch is in charge of only a function of transmitting and receiving packets, and setting, management, and control of the packets are all performed by a SDN controller. Accordingly, the malware in the SDN environment may badly influences the entire SDN environment through the SDN controller.

It may be identified in a flow table in the SDN environment illustrated in FIG. 1 that transmission of data from host A to host C is normally performed but transmission of data from host A to host B is dropped.

As illustrated in FIG. 1, the network programs in the traditional SDN environment may be driven without any restrictions. Therefore, the network manager needs to determine whether a program is malicious or benign before the program is installed.

Meanwhile, in the current SDN environment, there exists no system for determining whether a program is malicious or benign and no reference is established.

### PRIOR TECHNICAL DOCUMENTS

### Patent Documents

Korean Patent Application Publication No. 10-2016-1045373 (published on Dec. 30, 2016 and entitled “Method, Apparatus, and Computer Program for Analyzing Vulnerable Points in Software Defined Network”)

Korean Patent No. 10-1491699 (registered on Feb. 3, 2015 and entitled “Control Apparatus in Software Defined Networking and Operation Method thereof”).

### SUMMARY

Embodiments of the inventive concept provide an apparatus, a method, and a computer program for detecting malware in a software defined network, by which a security and safety of a software defined network may be improved by detecting whether a computer program is malicious before the malware is installed.

Embodiments of the inventive concept also provide an apparatus, a method, and a computer program for detecting malware in a software defined network, by which installation and execution of malware may be prevented by detecting malware without changing a traditional SDN system structure.

Embodiments of the inventive concept also provide an apparatus, a method, and a computer program for detecting malware in a software defined network, by which convenience and efficiency of a network manager may be improved by determining whether a network program is malicious by analyzing and detecting the network program within several seconds.

In accordance with an aspect of the inventive concept, there is provided an apparatus for detecting malware in a software defined network (SDN), the apparatus including a behavior graph deriving unit configured to derive a security-sensitive application programming interface (API) by analyzing a source code of a target network program generated in the software defined network and to derive a behavior graph of the target network program from the derived security-sensitive API, and a control unit configured to determine whether the target network program is malicious by characterizing the target network program from the derived behavior graph and clustering the target network program, to which machine learning is applied.

The behavior graph deriving unit may search for use of the security-sensitive API from APIs used by the target network program by analyzing the source code of the target network program.

The behavior graph deriving unit may perform a static analysis of analyzing a source code by recognizing control flows and data flows of the target network program.

The behavior graph deriving unit may derive the behavior graph including an execution sequence according to the use of the security-sensitive API by using the analysis result.

The control unit may characterize a frequency and a sequence of security-sensitive API calls, and a northbound interaction of a controller and the target network program in the software defined network, based on the derived behavior graph.

The control unit may cluster the target network program as malicious or benign category by applying machine learning to a feature of the target network program including the frequency and the sequence of the security-sensitive API calls, and the northbound interaction.

The control unit may classify the target network program, to which the machine learning is applied, as the malicious or benign category, based on a database unit in which categories according to a preset classification reference are stored and maintained.

The control unit may cluster the target network program by comparing a preset classification reference and a probability, and the derived behavior graph, and reflect the derived behavior graph to apply the reflected behavior graph to the database unit.

The control unit may determine at least one classification of true positive (TP), false positive (FP), true negative (TN), and false negative (FN) in the malicious or benign category of the target network program, based on the clustering.

In accordance with another aspect of the inventive concept, there is provided a computer program stored in a medium to detect malware in a software defined network (SDN), the computer program being configured to perform a function of deriving a security-sensitive application programming interface (API) by analyzing a source code of a target network program generated in the software defined network and deriving a behavior graph of the target network program from the derived security-sensitive API, and a function of determining whether the target network program is malicious by characterizing the target network program from the derived behavior graph and clustering the target network program, to which machine learning is applied.

In accordance with another aspect of the inventive concept, there is provided a method for detecting malware in a software defined network (SDN), the method including deriving a security-sensitive application programming interface (API) by analyzing a source code of a target network program generated in the software defined network and deriving a behavior graph of the target network program from the derived security-sensitive API, characterizing the target network program from the derived behavior graph, and determining whether the target network program is malicious by clustering a machining learning result applied to a feature of the target network program.

The deriving of the behavior graph may include searching for use of the security-sensitive API from APIs used by the target network program by analyzing the source code of the target network program.

The deriving of the behavior graph may include performing a static analysis of analyzing a source code by recognizing control flows and data flows of the target network program.

The deriving of the behavior graph may include deriving the behavior graph including an execution sequence according to the use of the security-sensitive API by using the analysis result.

The characterizing of the target network program may include characterizing a frequency and a sequence of security-sensitive API calls, and a northbound interaction of a controller and the target network program in the software defined network, based on the derived behavior graph.

The determining whether the target network program is malicious may include clustering the target network program as malicious or benign category by applying machine learning to a feature of the target network program including the frequency and the sequence of the security-sensitive API calls, and the northbound interaction.

The determining whether the target network program is malicious may include determining at least one classification of true positive (TP), false positive (FP), true negative (TN), and false negative (FN) in the malicious or benign category of the target network program, based on the clustering.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 illustrates an example of malware badly influencing a traditional SDN environment;

FIG. 2 illustrates a block diagram illustrating a configuration of an apparatus for detecting malware in a software defined network according to an embodiment of the inventive concept;

FIG. 3 illustrates a process of executing an apparatus for detecting malware in a software defined network according to an embodiment of the inventive concept;

FIGS. 4A to 4C illustrates an example of characterizing a target network program for clustering according to an embodiment of the inventive concept; and

FIG. 5 illustrates a flowchart of a method for detecting malware in a software defined network according to an embodiment of the inventive concept.

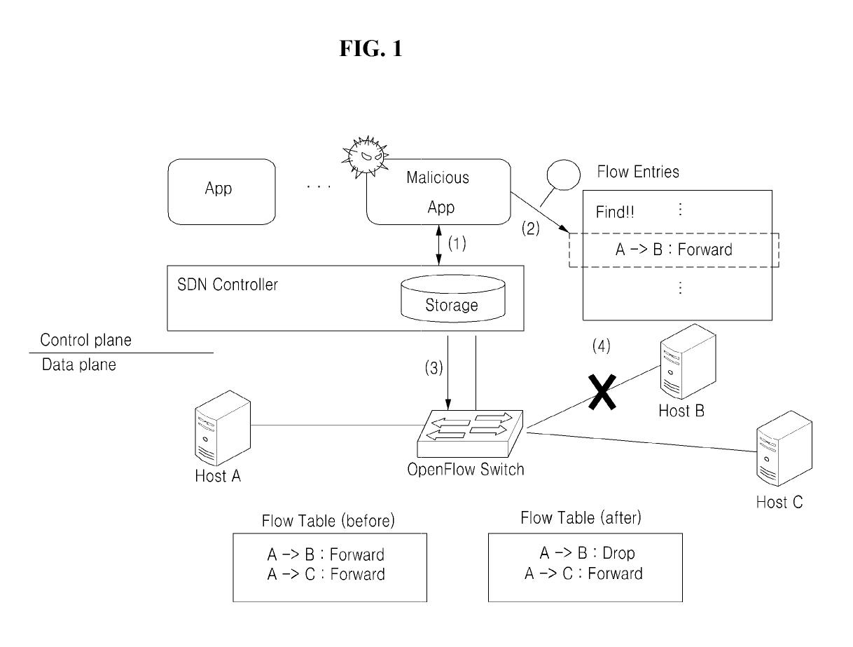

### DETAILED DESCRIPTION

Hereinafter, exemplary embodiments of the inventive concept will be described in detail with reference to the accompanying drawings. However, the inventive concept is neither limited nor restricted by the embodiments. Further, the same reference numerals in the drawings denote the same members.

Furthermore, the terminologies used herein are used to properly express the embodiments of the inventive concept, and may be changed according to the intentions of the user or the manager or the custom in the field to which the inventive concept pertains. Therefore, definition of the terms should be made according to the overall disclosure set forth herein.

As described above, the SDN network is realized completely differently from a conventional hardware based network. Accordingly, the techniques for detecting malware in the conventional hardware type network cannot be applied to an SDN network.

Moreover, because the SDN is currently in an initial stage, types and forms of malware that may be generated in an SDN network, and information on which damages may be generated by malware generated in the SDN network are not systematized and/or characterized to be accumulated.

Accordingly, in order to detect malware in the SDN network, the types and forms of the malware, and test modules for an arbitrary attack scenario have to be developed, respectively. Moreover, because the tests and managements require a network program to be directly analyzed, the safety and security of the network is dubious.

The inventive concept is adapted to solve the problems. The inventive concept proposes a standardized framework that may detect intrusion of malware that may be generated in an SDN network in advance.

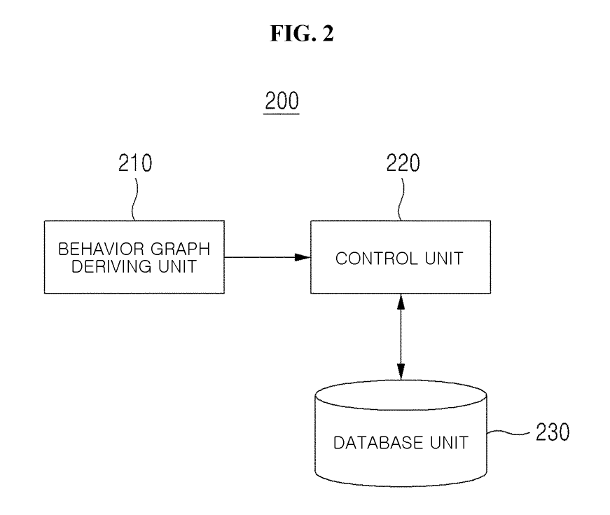

FIG. 2 illustrates a block diagram illustrating a configuration of an apparatus for detecting malware in a software defined network according to an embodiment of the inventive concept.

Referring to FIG. 2, the apparatus 200 for detecting malware in a software defined network extracts a feature of a behavior graph of a target network program generated in a software defined network to apply machine learning to the behavior graph, and determines whether the target network program is malicious by clustering the target network program.

Accordingly, the apparatus 200 for detecting malware in a software defined network according to an embodiment includes a behavior graph deriving unit 210 and a control unit 220.

The behavior graph deriving unit 210 derives a security-sensitive application programming interface (API) by analyzing the target network program generated in the software defined network (SDN), and derives a behavior graph of the target network program from the derived security-sensitive API.

The behavior graph deriving unit 210 may search for use of a security-sensitive API of the APIs used by the target network program by analyzing a source code of the target network program.

For example, the behavior graph deriving unit 210 may derive an interface (API) used by the target network program, and then may derive the API by searching for use of, among all the APIs, only security-sensitive APIs for increasing the accuracy of a detection system.

The security-sensitive API may be a northbound API that may control an important asset in the SDN system. Here, the important asset may include an application, a controller, a device, a flow, a host, an intent, a link, an open flow, a packet, routing, a topology, and a user.

The behavior graph deriving unit 210 may perform a static analysis of analyzing a source code by recognizing control flows and data flows of the security-sensitive API.

For example, the network program in the SDN system may control a network operation by installing a flow rule by utilizing the API Accordingly, the behavior graph deriving unit 210 may use a static analysis of analyzing a source code to recognize a malicious app and a benign app that cannot be clearly distinguished, more accurately.

Thereafter, the behavior graph deriving unit 210 may derive a behavior graph including an execution sequence according to use of the security-sensitive API by using the analysis result.

For example, the behavior graph deriving unit 210 may form a data dependency of at least two security-sensitive API calls as a periphery of the behavior graph by using an analysis result of static data flows through a static analysis, and may derive a behavior graph including an execution sequence according to a use relationship between the security-sensitive APIs and a unique ID.

Accordingly, the behavior graph according to an embodiment of the inventive concept has a low possibility of including false edges as compared with the traditional behavior graphs.

The control unit 220 characterizes a target network program from the derived behavior graph, and determines whether a target network program, to which machine learning is applied, is malicious by clustering the target network program.

For example, the control unit 220 may characterize a frequency and a sequence of security-sensitive API calls, and a northbound interaction of a controller and the target network program in the software defined network.

In more detail, the control unit 220 may derive a frequency of security-sensitive API calls by searching for all nodes in the derived behavior graph. According to an embodiment, the control unit 220 may derive a frequency of API calls in consideration of the meanings of the calls, and for example, may derive the frequency of the API calls by coupling the number of API calls pertaining to a flow class.

Further, the control unit 220 may derive the sequence of the security-sensitive API calls in the derived behavior graph. According to an embodiment, the control unit 220 may derive the sequence of API calls by measuring a correlation between an arbitrary API call sequence and another API call sequence of the security-sensitive APIs and the distance between the sequences.

Further, the control unit 220 may derive a northbound interaction of the controller and the target network program in the software defined network.

The program in the SDN system may interact with the SDN controller to determine meaningful networking through various northbound interactions. Accordingly, the control unit 220 may recognize information exchange frequencies between the target network program and the SDN controller to characterize a northbound interaction.

In detail, the control unit 220 may perform a data-flow analysis for medium parameters of northbound API calls in the derived behavior graph, and may derive an interaction by calculating the number of security-sensitive API calls and measuring a northbound interaction.

Thereafter, the control unit 220 may cluster the target network program as malicious or benign category by applying machine learning to a feature of the target network program including the frequency and the sequence of the security associated API calls, and the northbound interaction.

For example, the control unit 220 may cluster a machine learning model as a malicious or benign category, and may determine a classification according to clustering of the target network program by applying the generated machine learning model to the target network program.

According to an embodiment, the control unit 220 may cluster the target network program with reference clustering and sample tagging.

In detail, the reference clustering is a technique of arbitrarily sampling a sample program stored and maintained in a database unit to construct a (malicious or benign) reference cluster model. The control unit 220 may cluster a target network program located in any one of a malicious reference cluster model and a benign reference cluster model by applying machining learning to the target network program.

As another technique, the sample tagging is a technique of arbitrarily extracting about 20% of all the sample programs including a target network program to cluster the extracted sample programs and attaching a (malicious or benign) tag to the programs. The control unit 220 may determine whether the cluster is malicious or benign by recognizing the number of malicious tags or benign tags in the cluster, and may cluster the target network program by recognizing the location of the target network program in the cluster.

The control unit 220 may classify a target network program, to which machine learning is applied, as a malicious or benign category, based on the database unit 230 in which categories according to a preset classification reference is stored and maintained.

For example, the database unit 230 may include a reference cluster model that is constructed by sampling sample programs at random based on the reference clustering, and the reference cluster model may be corrected and supplemented by the control unit 220.

The control unit 220 may compare the preset classification reference and the probability with the derived behavior graph to cluster the target network program, and apply the derived behavior graph to the database unit 230.

For example, the control unit 220 may control clustering of the target network program based on the derived behavior graph, the frequency and the sequence of the security-sensitive API calls, the northbound interaction, any one classification reference of the reference clustering and sample tagging, and the probability, and may control correction and supplementation of the database unit 230 according to the clustering of the target network program.

According to an embodiment, the control unit 220 may learn a given state through trials and errors acquired in a process of clustering the target network program based on the machine learning, may determine and execute an action according to the determined policies, and may learn the environment while correcting and supplementing data stored and maintained in the database unit 230 based on the rewards acquired according to the action.

The control unit 220 may determine at least one classification of true positive (TP), false positive (FP), true negative (TN), and false negative (FN) in the malicious or benign category of the target network program, based on the clustering.

According to an embodiment, the control unit 220 may determine the classified TP and FN as a malicious app, and may determine the classified FP and TN as a benign app.

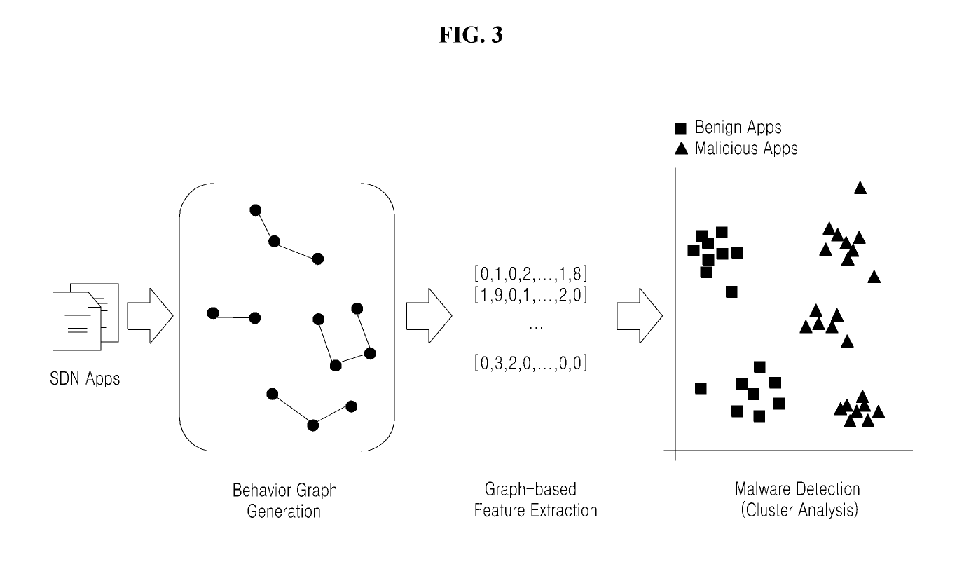

FIG. 3 illustrates a process of executing an apparatus for detecting malware in a software defined network according to an embodiment of the inventive concept.

Referring to FIG. 3, the apparatus for detecting malware in a software defined network according to an embodiment of the inventive concept may convert the target network program to a behavior graph, and may determine whether the target network program is malicious by extracting a feature of the target network program based on the behavior graph.

In more detail, in the first stage, a behavior graph of a target network program generated in a software defined network is derived. In the first stage, the apparatus for detecting malware in a software defined network according to an embodiment of the inventive concept may search for and derive a security-sensitive API of the target network program, and may derive a behavior graph including an execution sequence according to a use relationship of the security-sensitive API based on a static analysis.

Thereafter, in the second stage, a feature of the target network program is extracted based on the behavior graph.

In the second stage, the apparatus for detecting malware in a software defined network according to an embodiment of the inventive concept may characterize a frequency and a sequence of security-sensitive API calls, and a northbound interaction of a controller and the target network program in the software defined network.

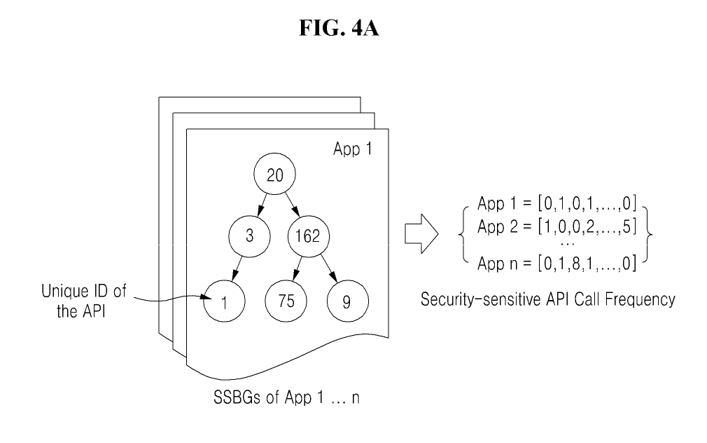

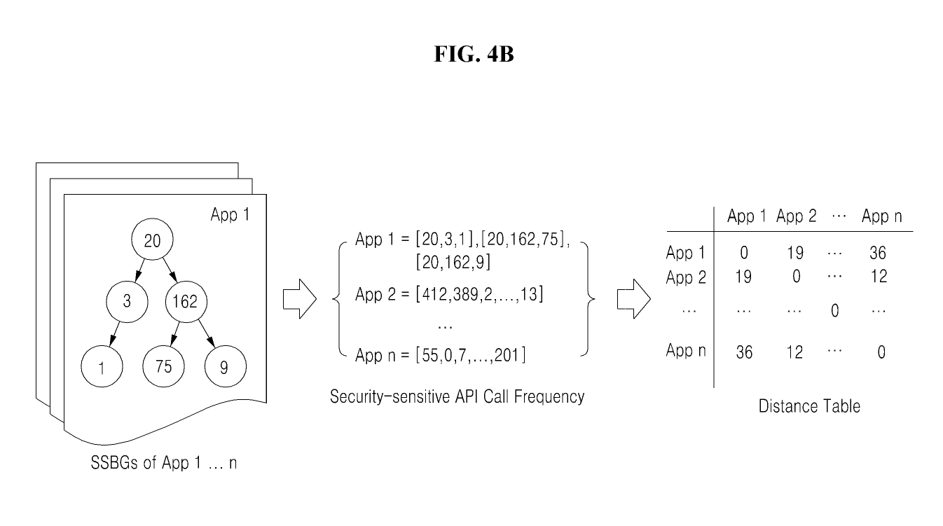

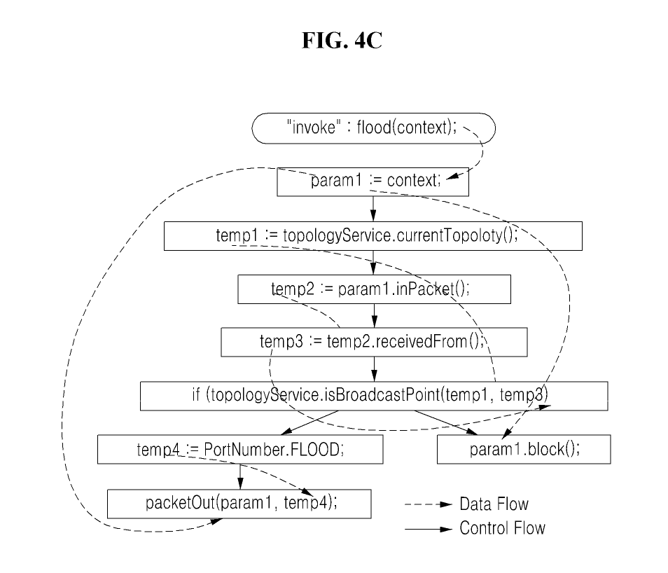

Hereinafter, an example of characterizing a target network program according to an embodiment of the inventive concept will be described in detail with reference to FIGS. 4A to 4C.

FIGS. 4A to 4C illustrates an example of characterizing a target network program for clustering according to an embodiment of the inventive concept.

In more detail, FIG. 4A illustrates an example of deriving a frequency of security-sensitive API calls in a target network program, FIG. 4B illustrates an example of deriving a sequence of security-sensitive API calls, and FIG. 4C illustrates an example of a northbound interaction.

Referring to FIG. 4A, the apparatus for detecting malware in a software defined network according to an embodiment of the inventive concept calculates a frequency of security-sensitive API calls by searching for all nodes in a behavior graph set (SSBGS or APp 1, . . . , and n) derived from a security-sensitive behavior graph (SSBGs).

According to an embodiment, the apparatus for detecting malware in a software defined network according to an embodiment of the inventive concept may consider the meanings of the calls to calculate the frequency of the security-sensitive API calls. For example, the apparatus may acquire a frequency of calls of total flow-sensitive APIs by coupling the frequency of the security-sensitive API calls included in the flow class.

Referring to FIG. 4A, the apparatus for detecting malware in a software defined network according to an embodiment of the inventive concept calculates a sequence of security-sensitive API calls by searching for all nodes in a behavior graph set (SSBGS or APp 1, . . . , and n) derived from a security-sensitive behavior graph (SSBGs).

According to an embodiment, the apparatus for detecting malware in a software defined network according to an embodiment of the inventive concept may extract a sequence of security-sensitive API calls by allocating unique IDs to the APIs of the target network program. Thereafter, a distance table of n columns and n rows including information on a correlation between the extracted security-sensitive API call sequence and another API call sequence may be formed.

The distance table may be used for clustering a malicious app or a benign app, and a difference between the API call sequences may be clearly shown. Further, the distance table may include information on distances between the sequences extracted from all application programs App1, App2, . . . , and App n that are different from that of the target network program.

Referring to FIG. 4C and Table 1, the apparatus for detecting malware in a software defined network according to an embodiment of the inventive concept may regard packetOut( ) API as a security-sensitive API, and may determine a northbound interaction of the target network program and the SDN controller by performing an data-flow analysis on two parameters of param1 and temp4.

Here, Table 1 represents example codes for a data-flow analysis.

TABLE 1

```
void flood (PacketContext context) {
  if (topologyService.isBroadcastPoint(
          topologyService.currentTopology( ),
          context.inPacket( ).receivedFrom( ))) {
    packetOut(context, PortNumber.FLOOD);
  } else {
    context.block( );
  }
}
```

For example, the apparatus for detecting malware in a software defined network according to an embodiment of the inventive concept may recognize use and definition of a parameter (i.e., a context) of a packetOut( ) method through Table 1.

In more detail, the apparatus for detecting malware in a software defined network according to an embodiment of the inventive concept may back-track use-defined chains by using a packetOut( ) call node, and may identify a location at which a parameter is defined and a (internal or external) location of a caller method (FLOOD( )).

Accordingly, if a parameter provided to a northbound API is declared and initialized in the SDN controller, the apparatus for detecting malware in a software defined network according to an embodiment of the inventive concept may determine that the target network program exchanges information with the controller and may characterize a northbound interaction of the controller and the target network program in the software defined network.

Referring back to FIG. 3, in the third stage, the apparatus for detecting malware in a software defined network according to an embodiment of the inventive concept determines whether the target network program is malicious.

In the third stage, the apparatus for detecting malware in a software defined network according to an embodiment of the inventive concept may divide the malicious app or the benign app into multiple clusters by using an algorithm to cluster the program.

For example, the apparatus for detecting malware in a software defined network according to an embodiment of the inventive concept may divide an SDN program into clusters by using a k-means clustering algorithm that divides an input object into k clusters, and clusters the divided clusters by determining whether the divided clusters are malicious or benign.

Thereafter, the apparatus for detecting malware in a software defined network according to an embodiment of the inventive concept may determine whether the target network program is malicious by using reference clustering or sample tagging.

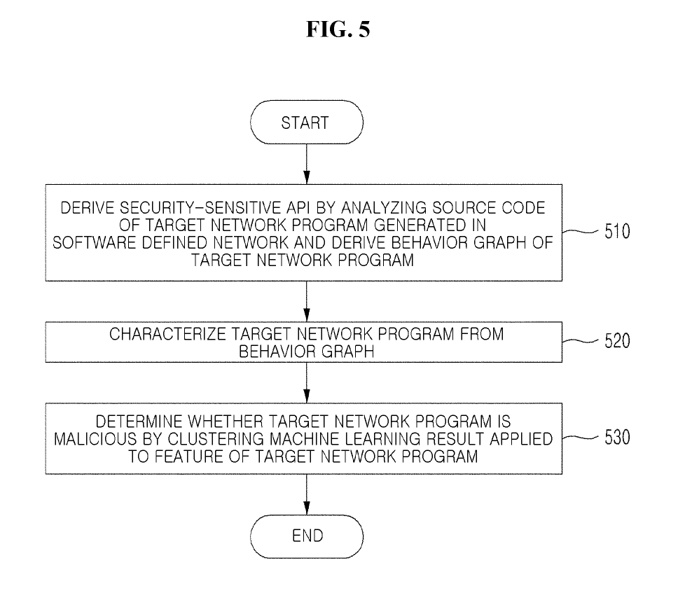

FIG. 5 illustrates a flowchart of a method for detecting malware in a software defined network according to an embodiment of the inventive concept.

The method illustrated in FIG. 5 may be performed by the apparatus of FIG. 2 for detecting malware in a software defined network according to an embodiment of the inventive concept.

Referring to FIG. 5, in operation 510, security-sensitive application programming interface (API) may be derived by analyzing the target network program generated in the software defined network (SDN), and a behavior graph of the target network program may be derived from the derived security-sensitive API.

In operation 510, use of a security-sensitive API of the APIs used by the target network program may be searched for by analyzing a source code of the target network program.

Operation 510 may be an operation of performing a static analysis of analyzing a source code by recognizing control flows and data flows of the target network program.

Thereafter, operation 510 is an operation of deriving a behavior graph including an execution sequence according to use of the security-sensitive API by using the analysis result.

In operation 520, the target network program is characterized from the derived behavior graph.

Operation 520 may be an operation of characterizing a frequency and a sequence of security-sensitive API calls, and a northbound interaction of a controller and the target network program in the software defined network.

In operation 530, it is determined whether the target network program is malicious, by clustering a machine learning result applied to the feature of the target network program.

Operation 530 may be an operation of clustering the target network program as malicious or benign category by applying machine learning to a feature of the target network program including the frequency and the sequence of the security associated API calls, and the northbound interaction.

Thereafter, operation 530 may be an operation of determining at least one classification of true positive (tP), false positive (FP), true negative (TN), and false negative (FN) in the malicious or benign category of the target network program, based on the clustering.

The above-described apparatus may be realized by a hardware element, a software element, and/or a combination of a hardware element and a software element. For example, the apparatus and the elements described in the embodiments, for example, may be realized by using one or more general-purpose computer or a specific-purpose computer such as a processor, a controller, an arithmetic logic unit (ALU), a digital signal processor, a microcomputer, a field programmable array (FPA), a programmable logic unit (PLU), a microprocessor, or any device that may execute and respond to an instruction. The processing device may perform an operation system and one or more software applications performed on the operating system. Further, the processing device may access, data, manipulate, process, and produce data in response to execution of software. Although one processing device is used for convenience of understanding, it may be easily understood by those skilled in the art that the processing device may include a plurality of processing elements and/or a plurality of types of processing elements. For example, the processing device may include a plurality of processors or one processor and one controller. Further, another processing configuration, such as a parallel processor, may be possible.

The software may include a computer program, a code, an instruction, or a combination of one or more thereof, and the processing device may be configured to be operated as desired or commands may be made to the processing device independently or collectively. The software and/or data may be permanently or temporarily embodied in any type of machine, a component, a physical device, virtual equipment, a computer storage medium or device, or a signal wave transmitted in order to be interpreted by the processing device or to provide an instruction or data to the processing device. The software may be dispersed on a computer system connected to a network, to be stored or executed in a dispersive method. The software and data may be stored in one or more computer readable recording media.

The method according to the embodiment may be implemented in the form of a program instruction that maybe performed through various computer means, and may be recorded in a computer readable medium. The computer readable medium may include a program instruction, a data file, and a data structure alone or in combination thereof. The program instruction recorded in the medium may be designed or configured particularly for the embodiment or may be a usable one known to those skilled in computer software. An example of the computer readable recording medium may include magnetic media such as a hard disk, a floppy disk, and a magnetic tape, optical recording media such as a CD-ROM and a DVD, magneto-optical media such as a floptical disk, and hardware devices that are particularly configured to store and perform a program instruction, such as a ROM, a RAM, and a flash memory. Further, an example of the program instruction may include high-level language codes which may be executed by a computer using an interpreter as well as machine languages created by using a compiler. The above-mentioned hardware device may be configured to be operated as one or more software module to perform operations of various embodiments, and the converse is applied.

According to an embodiment of the inventive concept, a security and a safety of a software defined network may be improved by detecting whether programs are malicious before the malicious apps are installed.

Further, according to an embodiment of the inventive concept, installation and execution of malware may be prevented by detecting malware without changing a traditional SDN system structure.

Further, according to an embodiment, convenience and efficiency of a network manager may be improved by determining whether one network program is malicious by analyzing and detecting the network program in several seconds.

Although the embodiments of the present disclosure have been described with reference to the limited embodiments and the drawings, the inventive concept may be variously corrected and modified from the above description by those skilled in the art to which the inventive concept pertains. For example, the above-described technologies can achieve a suitable result even though they are performed in different sequences from those of the above-mentioned method and/or coupled or combined in different forms from the method in which the constituent elements such as the system, the architecture, the device, or the circuit are described, or replaced or substituted by other constituent elements or equivalents.

Therefore, the other implementations, other embodiments, and the equivalents of the claims pertain to the scope of the claims.

The embodiments of the invention in which an exclusive property or privilege is claimed are defined as follows:

1. An apparatus for detecting malware in a software defined network (SDN), the apparatus comprising:
a behavior graph deriving unit configured to derive a security-sensitive application programming interface (API) by analyzing a source code of a target network program generated in the software defined network and to derive a behavior graph of the target network program from the derived security-sensitive API; and
a control unit configured to determine whether the target network program is malicious by characterizing the target network program from the derived behavior graph and clustering the target network program, to which machine learning is applied.

2. The apparatus of claim 1, wherein the behavior graph deriving unit searches for use of the security-sensitive API from APIs used by the target network program by analyzing the source code of the target network program.

3. The apparatus of claim 2, wherein the behavior graph deriving unit performs a static analysis of analyzing a source code by recognizing control flows and data flows of the target network program.

4. The apparatus of claim 3, wherein the behavior graph deriving unit derives the behavior graph including an execution sequence according to the use of the security-sensitive API by using the analysis result.

5. The apparatus of claim 1, wherein the control unit characterizes a frequency and a sequence of security-sensitive API calls, and a northbound interaction of a controller and the target network program in the software defined network, based on the derived behavior graph.

6. The apparatus of claim 5, wherein the control unit clusters the target network program as malicious or benign category by applying machine learning to a feature of the target network program including the frequency and the sequence of the security-sensitive API calls, and the northbound interaction.

7. The apparatus of claim 6, wherein the control unit classifies the target network program, to which the machine learning is applied, as the malicious or benign category, based on a database unit in which categories according to a preset classification reference are stored and maintained.

8. The apparatus of claim 7, wherein the control unit clusters the target network program by comparing a preset classification reference and a probability, and the derived behavior graph, and reflects the derived behavior graph to apply the reflected behavior graph to the database unit.

9. The apparatus of claim 1, wherein the control unit determines at least one classification of true positive (TP), false positive (FP), true negative (TN), and false negative (FN) in the malicious or benign category of the target network program, based on the clustering.

10. A computer program stored in a medium to detect malware in a software defined network (SDN), the computer program being configured to perform:
a function of deriving a security-sensitive application programming interface (API) by analyzing a source code of a target network program generated in the software defined network and deriving a behavior graph of the target network program from the derived security-sensitive API; and
a function of determining whether the target network program is malicious by characterizing the target network program from the derived behavior graph and clustering the target network program, to which machine learning is applied.

11. A method for detecting malware in a software defined network (SDN), the method comprising:
deriving a security-sensitive application programming interface (API) by analyzing a source code of a target network program generated in the software defined network and deriving a behavior graph of the target network program from the derived security-sensitive API;
characterizing the target network program from the derived behavior graph; and
determining whether the target network program is malicious by clustering a machining learning result applied to a feature of the target network program.

12. The method of claim 11, wherein the deriving of the behavior graph includes:
searching for use of the security-sensitive API from APIs used by the target network program by analyzing the source code of the target network program.

13. The method of claim 12, wherein the deriving of the behavior graph includes:
performing a static analysis of analyzing a source code by recognizing control flows and data flows of the target network program.

14. The method of claim 13, wherein the deriving of the behavior graph includes:
deriving the behavior graph including an execution sequence according to the use of the security-sensitive API by using the analysis result.

15. The method of claim 11, wherein the characterizing of the target network program includes:
characterizing a frequency and a sequence of security-sensitive API calls, and a northbound interaction of a controller and the target network program in the software defined network, based on the derived behavior graph.

16. The method of claim 15, wherein the determining whether the target network program is malicious includes:
clustering the target network program as malicious or benign category by applying machine learning to a feature of the target network program including the frequency and the sequence of the security-sensitive API calls, and the northbound interaction.

17. The method of claim 16, wherein the determining whether the target network program is malicious includes:
determining at least one classification of true positive (TP), false positive (FP), true negative (TN), and false negative (FN) in the malicious or benign category of the target network program, based on the clustering.
